(19) United States
(12) Patent Application Publication
(10) Pub. No.: US 2012/0271826 A1
(43) Pub. Date: Oct. 25, 2012

(54) DATA COLLECTING METHOD FOR DETECTION AND ON-TIME WARNING SYSTEM OF INDUSTRIAL PROCESS

(75) Inventor: Su Young Kim, Daejeon (KR)

(73) Assignee: BNF Technology Inc., Daejeon (KR)

(21) Appl. No.: 13/519,070

(22) PCT Filed: Apr. 18, 2011
(86) PCT No.: PCT/KR2011/002758

§ 371 Date: Jun. 25, 2012

(30) Foreign Application Priority Data
Apr. 19, 2010 (KR) 10-2010-0035755

(51) Int. Cl. G06F 17/30

(52) U.S. Cl. 707/737; 707/E17.089

(57) ABSTRACT

A data collection method for a process margin monitoring system of industrial equipment includes preparing a learning data set based on data determined to be normal in an operation history of the industrial equipment so that the learning data set is sorted for each operation mode, in a case in which the industrial equipment includes equipment units performing the same functions, receiving data for each of the equipment units and processing the received data as data for the equipment units, sorting and grouping associated ones of the data in the learning data set, and sampling the collected data to reduce the amount of data.

### BACKGROUND OF THE INVENTION

1. Field of the Invention

The present invention relates to a data collection method for a process margin monitoring system of industrial equipment and a storage medium for storing the same, and more particularly to a data collection method for a process margin monitoring system of industrial equipment that is capable of collecting learning data from a database of a computer in a power plant and converting the data into a form in which the data can be easily learned in realizing a monitoring system for analyzing process margin of industrial equipment based on a statistical learning method and a storage medium for storing the same.

2. Description of the Related Art

Industrial equipment includes a plurality of systems and instruments for achieving a specific purpose. Generally, one or more measuring instruments for confirming an operation and safety state of the industrial equipment are installed such that the operation and safety state of the industrial equipment can be measured offline or online.

Efficiency and safety of the industrial equipment are changed depending upon external conditions (temperature, pressure, or humidity of the atmosphere; temperature of seawater or rainfall in a case in which a coolant is needed), characteristics of fuel supplied to the industrial equipment, a degradation degree of the industrial equipment, and an operation range. In terms of cost, a change range in which the efficiency and safety of the industrial equipment are maintained is called process margin. Most industrial equipment has a stoppage/protection function for stopping/protecting a specific system or instrument in order to prevent the operation of the industrial equipment exceeding such process margin. In order to realize such a stoppage/protection function, a control device is provided for forcibly stopping the industrial equipment if a value of a specific operation variable exceeds a set value for stoppage/protection.

The process margin and the set value for stoppage/protection are interdependent variables. If the set value for stoppage/protection is set to too large a value, the process margin is relatively increased, and therefore, cost benefit obtained by operating the industrial equipment is increased; however, serious accidents may occur with the result that the industrial equipment may be stopped for a long period of time. On the other hand, if the set value for stoppage/protection is set to a too small value, probability of accident occurrence is lowered; however, the process margin is decreased with the result that the industrial equipment may frequently be stopped, and therefore, cost benefit obtained by operating the industrial equipment is decreased.

Therefore, both of these facets should be considered when deciding overall process margin. As high degree of safety is required, a conservative value, including external conditions, supplied fuel, a degradation degree of the industrial equipment, and an operation range, is generally used to decide process margin.

However, it is very difficult to decide overall process margin in various situations, such as external conditions, supplied fuel, a degradation degree of the industrial equipment, and an operation range.

On the other hand, a set value for preliminary stoppage/protection is generally provided so that an operator can prepare for the stoppage of the industrial equipment or can take proper measures to normalize the industrial equipment before the value of the specific operation variable reaches the set value for stoppage/protection.

However, such a set value for preliminary stoppage/protection is generally a static value. The value is not changed once the value is set. Although the value is changed, the set value is set as a function with respect to one or two conditions indicating characteristics of the industrial equipment.

If process is within the above set value for stoppage/protection, therefore, it cannot be determined whether the process is really normal or abnormal. Also, it is difficult to expect time during which a process problem is transmitted to the set value. For this reason, it is impossible to take a proper measure until a very tense situation is caused.

Technology has been well known that is capable of performing dynamic monitoring and issuing a timely alarm with respect to a stoppage/protection signal of the industrial equipment based on a series of statistical learning and prediction models in order to solve the above-mentioned conventional problems.

### SUMMARY OF THE INVENTION

Therefore, the present invention has been made in view of the above problems, and it is an object of the present invention to provide a data collection method for a process margin monitoring system of industrial equipment that is capable of collecting learning data from a database of a computer in a power plant and converting the data into a form in which the data can be easily learned in realizing a monitoring system for analyzing process margin of industrial equipment based on a statistical learning method and a storage medium for storing the same.

In accordance with an aspect of the present invention, the above and other objects can be accomplished by the provision of a data collection method for a process margin monitoring system of industrial equipment, including preparing a learning data set based on data determined to be normal in an operation history of the industrial equipment so that the learning data set is sorted for each operation mode, in a case in which the industrial equipment includes a plurality of equipment units performing the same functions, receiving data for each of the equipment units and processing the received data as data for the equipment units, sorting and grouping associated ones of the data in the learning data set, and sampling the collected data to reduce the number of data.

The learning data set may include a first data set to an N-th data set (N being a natural number equal to or greater than 2) depending upon a scale of data to be collected or time when data are collected.

The first data set may include signals related to a specific equipment unit of the industrial equipment for monitoring process margin of the specific equipment unit, the second data set may include signals related to the entirety of the industrial equipment for monitoring process margin of the entirety of the industrial equipment, and the third data set may include signals regarding the entirety or a portion of the industrial equipment immediately after a specific event is generated in the entirety or the portion of the industrial equipment.

The data collection method may further includes, in a case in which the learning data set comprises data displayed as digital signals, collecting analog signal that can substitute for the digital signal and converting the digital signal into the analog signal.

The grouping step may include regarding variables, a correlation coefficient between which is equal to or greater to a set value, as belonging to the same group, calculating a smoothness parameter with respect to the variables regarded as belonging to the same group using a 4-fold validation method, putting combinations of all variables in the group besides the variables regarded as belonging to the same group to calculate a square sum of residuals while calculating the smoothness parameter using the 4-fold validation method, and, in a case in which a decrease ratio of a square sum of residuals immediately after a square sum of specific residuals to the square sum of specific residuals is equal to or less than a set value, terminating grouping at a time when the square sum of specific residuals is calculated.

The step of calculating the square sum of residuals may include sorting and using only variables related to characteristics of the equipment among the variables besides the variables regarded as belonging to the same group in consideration of characteristics of the equipment.

The correlation coefficient may be analyzed by the following mathematical expression.

$${ρ}_{XY} = \frac{1}{N} {\sum }_{i = 1}^{N} ( \frac{{X}_{i} - {μ}_{X}}{{σ}_{X}} ) ( \frac{{Y}_{i} - {μ}_{Y}}{{σ}_{Y}} )$$

Where, ρ_{XY} indicates a correlation coefficient between variables X and Y, Xᵢ indicates an i-th value on the basis of a sampling section of learning data, Yᵢ indicates an i-th value on the basis of a sampling section of learning data (Y is a variable different than X), μ_{X} indicates the average of a variable X, μ_{Y} indicates the average of a variable Y, σ_{X} indicates standard deviation of a variable X, σ_{Y} indicates standard deviation of a variable Y, and N indicates the number of data collection intervals in a sampling section of learning data.

The data sampling step may include performing dispersion of a value of a specific variable on the basis of a grid size to reduce the number of data related to the variable in a corresponding grid.

The data sampling step may include calculating standard deviation (σ_{X}) of a value of a specific variable and reducing the number of data related to the variable in a corresponding grid on the basis of a grid size (GridSize_{X}) calculated by the following mathematical expression according to set resolution.

$${GridSize}_{X} = \frac{10 {σ}_{X}}{Resolution}$$

The number of data left in the grid may be decided by the product of the number of data related to the variable in the corresponding grid and a set rate, and at least one of the data is left in each grid.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing a general power generation system as industrial equipment;

FIG. 2 is a view showing a construction example of multiple learning data sets in a data collection method for a process margin monitoring system of industrial equipment according to an embodiment of the present invention;

FIG. 3 is a view showing a user interface for selecting a learning data set in the data collection method for the process margin monitoring system of industrial equipment according to the embodiment of the present invention;

FIG. 4 is a view showing a collection example of analog data or digital data in the data collection method for the process margin monitoring system of industrial equipment according to the embodiment of the present invention;

FIG. 5 is a view showing imaginary tag creation in the data collection method for the process margin monitoring system of industrial equipment according to the embodiment of the present invention;

FIGS. 6 and 7 are views showing stepwise variable selection in the data collection method for the process margin monitoring system of industrial equipment according to the embodiment of the present invention;

FIG. 8 is a view showing stepwise variable selection results and cross variable grouping results in the data collection method for the process margin monitoring system of industrial equipment according to the embodiment of the present invention; and

FIGS. 9 and 10 are views illustrating a data compression principle in the data collection method for the process margin monitoring system of industrial equipment according to the embodiment of the present invention.

### DETAILED DESCRIPTION OF THE INVENTION

Now, preferred embodiments of the present invention will be described in detail with reference to the accompanying drawings so as to explain the present invention in detail to such an extent that a person having ordinary skill in the art to which the present invention pertains can easily make the present invention. The object, operation, and effects, and, in addition, other objects, features, and operational advantages of the present invention will be more clearly understood from the following detailed description.

For reference, embodiments disclosed in this specification are selected from several possible embodiments and presented as the most preferred embodiments to assist those skilled in the art to understand the present invention. Therefore, the technical concept of the present invention is not restricted or limited to the disclosed embodiments, and it should be understood that various modifications, additions and substitutions are possible, and, in addition, equivalents thereof are also possible, without departing from the technical concept of the present invention.

A process margin monitoring system for issuing a timely alarm about process margin based on a statistical learning and prediction model has been developed. The process margin monitoring system is characterized by distinguishing between errors of a measuring instrument and abnormality of equipment using statistical data (hereinafter, referred to as “learning data”) obtained from an operation history of the equipment.

Accuracy of the process margin monitoring system depends upon how reliably learning data are collected from the operation history of the equipment and how the collected learning data are grouped so that the learning data can be used to construct a prediction model.

Conditions required to improve accuracy of the process margin monitoring system may be divided into the following detailed items.

(1) How to Collect Data

This is a method of selecting time when collection of learning data from a database installed in a computer of a power plant is started and time when collection of learning data from the database is ended.

(2) How to Collect Data in a Case in which Power Generation Equipment is Normally Operated and in a Case in which the Power Generation Equipment is not Normally Operated

A normal state means that the equipment is maintained in a stable state without change of operation conditions.

Generally, data collected at that time are useful to construct a statistical model. On the other hand, data obtained when the state of the power generation equipment is changed due to start, stoppage, or various control logics are not useful to construct a statistical model. For this reason, it is necessary to provide a method of collecting data from the database installed in the computer of the power plant while distinguishing between a normal state and an abnormal state and inputting the collected data to the process margin monitoring system.

(3) How to Collect Analog Data and Digital Data

Unlike an analog signal indicating a general process signal, a digital signal for mainly indicating operation states of equipment, such as an open or closed state of a valve and an operation/stoppage state of a pump, plays an important role, but a problem occur when the digital signal is reflected in a statistical learning model developed based on analog data. For this reason, it is necessary to provide a method of receiving digital data from the database installed in the computer of the power plant and inputting the received digital data to the process margin monitoring system.

(4) How to Process Data Having the Same Characteristics Provided by a Plurality of Equipment Units

In many cases, an industrial equipment unit for performing an important function has one or more backup equipment units that are capable of performing the same function. For example, in a case in which several pumps are operated while another pump remains stopped, and one of the pumps under operation is stopped for a certain reason, the pump remaining stopped is operated to substitute for the failed pump. In this case, the total number of equipment units that are operated is not changed, and therefore, the operation condition is not changed. In providing a user with monitoring results, however, a portion to be changed is generated since there is a change in the equipment units under operation. That is, it is necessary to provide a method of receiving data having the same characteristics provided by a plurality of equipment units from the database installed in the computer of the power plant, processing the received data, and inputting the processed data to the process margin monitoring system.

(5) How to Select an Optimal Combination in Grouping Data

A signal list for monitoring the power generation equipment is generally enormous. Such a signal list includes not only signals important to confirm process margin of the equipment but also unnecessary signals. The simplest grouping method is confirming a correlation coefficient between signals and grouping signals having high correlation. However, grouping results may not be consistent depending upon a collection policy of learning data. Therefore, it is necessary to provide a method of grouping data based on a statistical method and engineering knowledge of equipment and inputting the grouped data to the process margin monitoring system.

(6) How to Reduce Collected Data to Such an Extent that Learning is Really Possible

Generally, if a sampling interval is very short although data are collected for a short period of time, the amount of the collected data is enormous. Also, for large-sized power generation equipment, a signal list to be monitored is very large. For this reason, it is not easy to process a huge amount of calculation necessary to construct a statistical learning model although a high-performance computer is used. Therefore, it is necessary to provide a method of reducing collected data with the minimum loss so that the data can be really learned and inputting the reduced data to the process margin monitoring system.

Hereinafter, methods of satisfying conditions required to improve accuracy of the process margin monitoring system will be described in detail according to the respective detailed items thereof. (1) Collection of Data (Construction of Multiple Learning Data Sets)

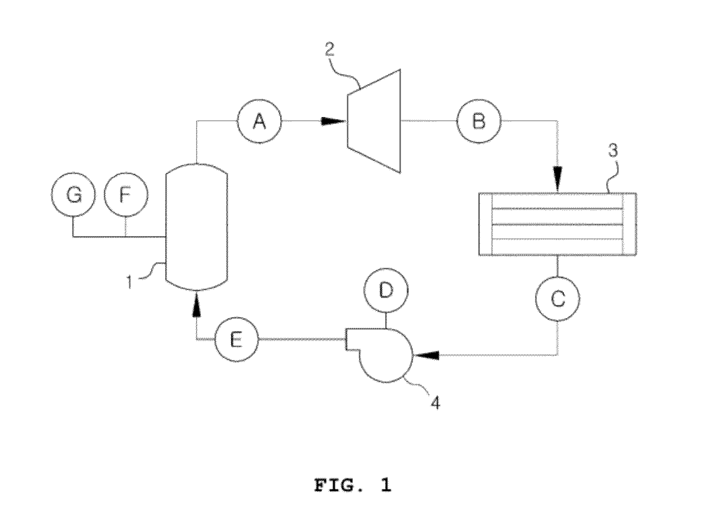

FIG. 1 is a schematic view showing a general power generation system as industrial equipment. As shown in FIG. 1, the general power generation system includes a steam generation equipment unit 1, such as a boiler of a steam power plant or a steam generator of a nuclear power plant, a steam turbine 2 connected to the steam generation equipment unit 1, a condenser 3 connected to the steam turbine 2, and a pump 4 connected between the condenser 3 and the steam generation equipment unit 1. In FIG. 1, reference symbols A to G denote signals that can be obtained by sensors installed at the respective equipment units. Reference symbol A denotes an outlet pressure signal of the steam generation equipment unit 1, reference symbol B denotes a pressure signal of the condenser 3, reference symbol C denotes a temperature signal of the condenser 3, reference symbol D denotes an outlet pressure signal of the pump 4, reference symbol E denotes a supplied water flow rate signal, reference symbol F denotes an internal pressure signal of the steam generation equipment unit 1, and reference symbol G denotes an internal temperature signal of the steam generation equipment unit 1.

Ideal learning data must be obtained from operation conditions of normal equipment having no deterioration with time and no lowering of efficiency. Also, such ideal learning data must include operation data based on the combination of all external conditions (temperature, pressure, or humidity of the atmosphere; temperature of seawater or rainfall in a case in which a coolant is needed) and all internal conditions (characteristics of supplied fuel or an operation range). Since it is impossible to perfectly collect such data in actuality, however, learning data are prepared using the following method.

First, two or more learning data sets are constructed. Since learning data function as a reference target which is compared with a present equipment state, multiple learning data sets may be constructed correspondingly. Consequently, the learning data sets may include a first data set, a second data set, a third data set . . . , and an N-th data set (N being a natural number) depending upon the scale of data to be collected or the time when data are collected.

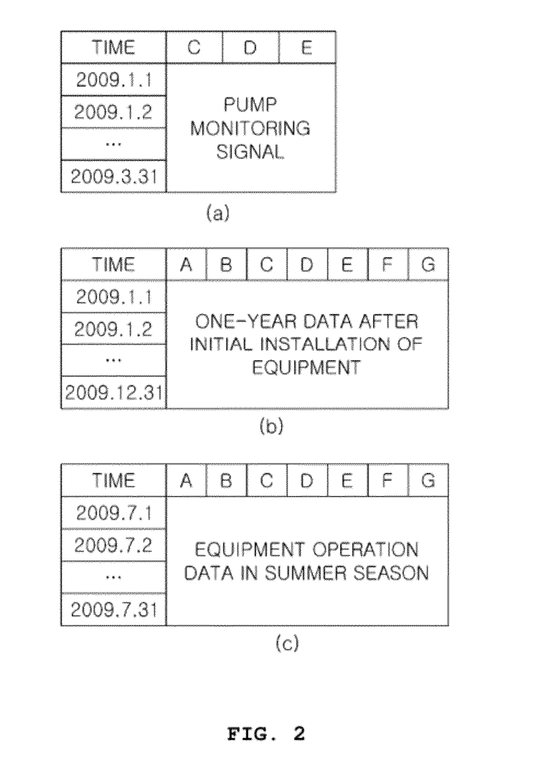

On the assumption that three learning data sets are constructed as shown in FIG. 2, a first data set has a learning database including signals C, D, and E for monitoring process margin of a specific equipment unit (for example, the pump 4 of the power generation system). Three-month data collected immediately after replacement or maintenance of the equipment unit are periodically collected and stored in the database (see FIG. 2(a)). A second data set has a learning database including all signals A, B, C, D, E, F, and G for monitoring process margin of all of the equipment units. One-year operation history data after initial installation of the equipment units are stored in the database. The second data set is used to confirm how much different a present state of the power generation equipment is than a design value (see FIG. 2(b)). A third data set includes signals A, B, C, D, E, F, and G regarding all of the equipment units. In the third data set, the signals are periodically updated on a per specific event basis. For example, signals are periodically updated three months after every planned preventive stop, in the summer season or the winter season every year, or three months after a specific equipment unit is replaced. The third data set may be used to observe a certain state of the equipment on the basis of an equipment condition immediately after a specific event is generated (see FIG. 2(c)).

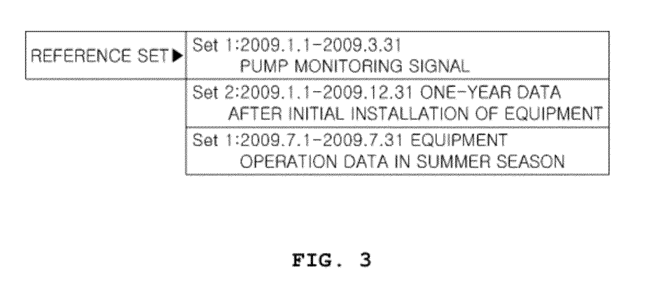

A statistical learning method is divided into a learning mode and an execution mode. Each of the multiple learning data sets is used to generate a model in the learning mode, and provides a proper interface, by which a user can select one of the multiple learning data sets when the execution mode is commenced. FIG. 3 shows a user interface in a case in which one of the learning data sets constructed in FIG. 2 is selected.

(2) Collection Data in a Case in which the Equipment is Normally Operated and in a Case in which the Equipment is not Normally Operated (Collection of Learning Data for each Operation Mode)

For most equipment, the equipment is started from a state in which the equipment is stopped, an operation state of the equipment is maintained in a predetermined state, and then the equipment is stopped after a predetermined time.

Consequently, the mode of the equipment may be divided into a start mode, a normal operation mode, and a stop mode. According to circumstances, the operation mode may be subdivided. When collecting learning data, data sets are sorted on a per operation mode basis. In a case in which data are sorted for each of the operation modes, grouping reliability is increased, and a model is simplified, whereby accuracy of the overall monitoring system is improved. Consequently, learning data are sorted and collected for each operation mode using the multiple learning data selection method described in paragraph (1).

That is, a model suitable for a corresponding operation mode is used in the execution mode. In a case in which monitoring is performed only in a specific operation mode, such monitoring is performed only when data obtained in an operation condition not exceeding a data range prepared in the learning mode are input. In a case in which the state of the system is not different than the above condition, an alarm indicating that reliability of the output result is low is issued to a user, or a calculation is automatically bypassed.

(3) Collection of Analog Data and Digital Data

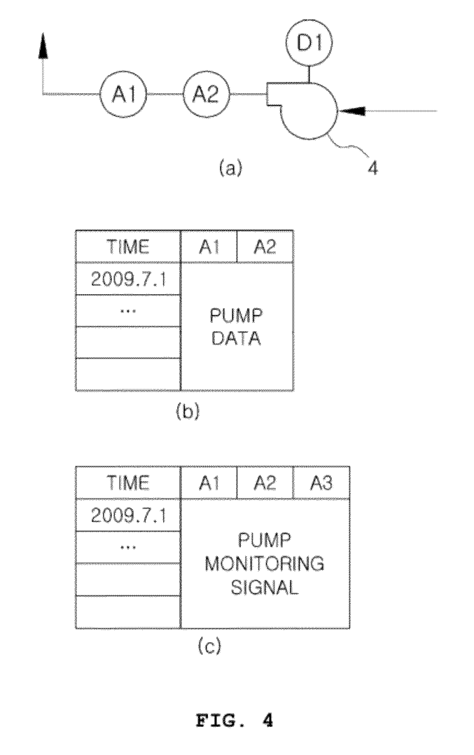

If modeling is difficult in using the statistical learning method in a case in which learning data include a digital signal, learning data may be collected using an analog signal that can substitute for the digital signal. For example, if modeling of a digital signal indicating an open or closed state of a valve is difficult, flow rate, pressure, or temperature at a pipe located downstream of the valve is included in the learning data so that the open or closed state of the valve can be indirectly known. FIG. 4 is a view showing a collection example of analog data or digital data. In FIG. 4(a), reference symbol A1 denotes an analog signal regarding pressure of an outlet part of the pump 4, reference symbol A2 denotes an analog signal regarding temperature of the outlet part of the pump 4, and reference symbol D1 denotes a digital signal regarding an ON/OFF state of the pump 4. FIG. 4(b) illustrates a data set in a case in which the use of digital data is impossible, and FIG. 4(c) illustrates a data set in a case in which the use of digital data is possible.

If kernel regression analysis is used as a model of the learning data, analog data and digital data may be mixed. Also, important digital data must be designated as the same group as the learning data. In a grouping method based only on a linear correlation coefficient used in the existing statistical learning method, important digital data may be lost during grouping. For this reason, a method of finding an optimal grouping combination, which will be described below, must be utilized.

In the execution mode, however, the result of a digital signal may be an intermediate value or a value deviating from 0 or 1 as well as 0 or 1. In this case, it is determined that indication of opening/closing or stop/operation that the digital signal means may be incorrect.

(4) Processing of Data Having the Same Characteristics Provided by a Plurality of Equipment Units (Creation of Imaginary Analog/Digital Tags)

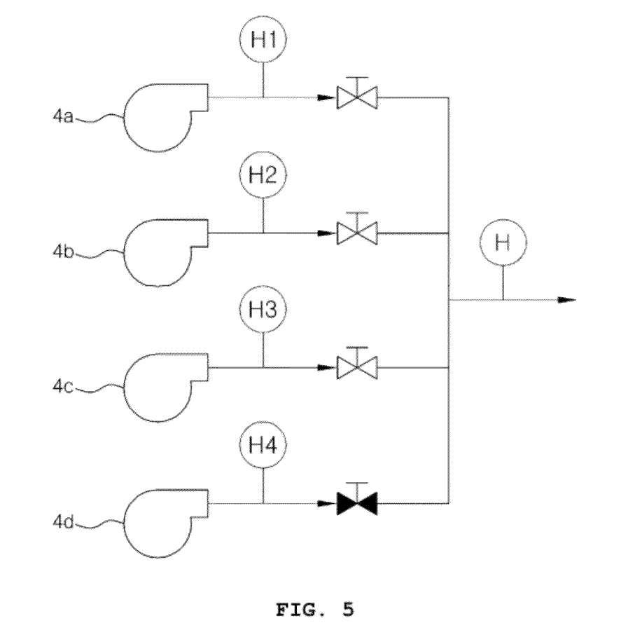

Learning data are not collected on an equipment basis but on a function basis. In a case in which data having the same characteristics are provided by a plurality of equipment units, therefore, imaginary tags are given. In order to give such imaginary tags, it is assumed that three of the four pumps 4a, 4b, 4c, and 4d are operated, and the remaining one is stopped so that it can be operated in case of emergency, as shown in FIG. 5. That is, it is assumed that each of the pumps has a capacity of 33.3%, and three of the four pumps must be operated. The four pumps 4a, 4b, 4c, and 4d are different equipment units but perform the same function. Consequently, learning data must not use flow meters or thermometers located at the outlets of the four pumps 4a, 4b, 4c, and 4d as denoted by H1 to H4 but use a flow meter or thermometer installed at a position at which the four pumps 4a, 4b, 4c, and 4d are joined together as denoted by H. If a desired measuring instrument is not provided at this position, an imaginary tag is created to substitute for a real flow meter or thermometer. An imaginary tag is used which is configured as a method of summing flow rate of the three operated pumps or averaging temperature of the three operated pumps based on operation states of the respective pumps.

A concept of such an imaginary tag may be used to indicate a position at which a measuring instrument is not really installed although a signal is required, a position at which such a measuring instrument cannot be installed, or a physical amount that can be measured. For example, if it is wished to utilize enthalpy as a signal at the points H1 to H4 of FIG. 5 in addition to the thermometers and manometers at the outlet side positions H1 to H4 of the pumps 4a, 4b, 4c, and 4d, an imaginary tag of enthalpy, a function of temperature and pressure, may be made and used at the positions H1 to H4.

(5) Selection of an Optimal Combination in Grouping Data (Stepwise Variable Selection and Cross Grouping)

In order to improve accuracy of grouping, various kinds of singularity included in learning data must be basically removed. Representative examples of singularity may include a case in which data are not input, such as ‘Bad input’ and a case in which data are input but are large or small to such an extent that the data temporarily deviate excessively from a normal range, such as ‘Out of range.’ In a case in which data having such singularity are generated, data of all variables acquired at that time are simultaneously removed to improve reliability of learning data. All variables having no change during sampling of the learning data are processed as ‘Bad input’ so that the variables cannot function as noise in modeling.

Learning data include information useful to inform a user of the state of a specific equipment unit and information useless to inform the state of a specific equipment unit. Also, all signals do not indicate states of all of the equipment units in the system although the signals include useful information. For this reason, it is necessary to group signals including information useful to inspect a state of each of the equipment units to be inspected. When the grouping is performed as described above, it is possible to remove signals including useless information from the learning data, thereby reducing the number of signals necessary to monitor a specific equipment unit to an appropriate level.

Generally, a correlation coefficient used as a basis of grouping in the statistical learning method is analyzed with respect to all variable pairs constituting learning data, and is calculated as represented by the following mathematical expression 1. If the calculated value of the correlation coefficient is equal to or greater than a set value, the variables are regarded as the learning data. On the other hand, if the calculated value of the correlation coefficient is less than the predetermined value, the variables are excluded from the learning data. The set value is input by a user.

$${ρ}_{XY} = \frac{1}{N} {\sum }_{i = 1}^{N} ( \frac{{X}_{i} - {μ}_{X}}{{σ}_{X}} ) ( \frac{{Y}_{i} - {μ}_{Y}}{{σ}_{Y}} ) \qquad [ Mathematical expression 1 ]$$

Where, ρ_{XY} indicates a correlation coefficient between variables X and Y, Xᵢ indicates an i-th value on the basis of a sampling section of learning data, Yᵢ indicates an i-th value on the basis of a sampling section of learning data (Y is a variable different than X), μ_{X} indicates the average of a variable X, μ_{Y} indicates the average of a variable Y, σ_{X} indicates standard deviation of a variable X, σ_{Y} indicates standard deviation of a variable Y, and N indicates the number of data collection intervals in a sampling section of learning data.

However, grouping depending on the correlation coefficient as described above has the following two problems.

First, a correlation coefficient between variables which should have a physical relationship is very low with the result that the variables may not belong to the same group. A correlation coefficient indicates a linear relationship between two variables. However, linearity of two certain variables may be differently analyzed depending upon a sampling period of learning data. For example, variables, such as an outside air condition, a seawater or rainfall condition, and a fuel condition, affect overall performance of the power generation equipment but are not sufficiently reflected in the correlation coefficient since such variables change much more slowly than a process change of the equipment. Such variables may be regarded as independent variables of the overall system. That is, change of the system does not affect such variables, but such variables affect change of the system.

Second, if such variables belong to a specific group, the variables cannot belong to other groups. Since independent variables of the system affect all groups, it is necessary for a plurality of groups to have the independent variables jointly.

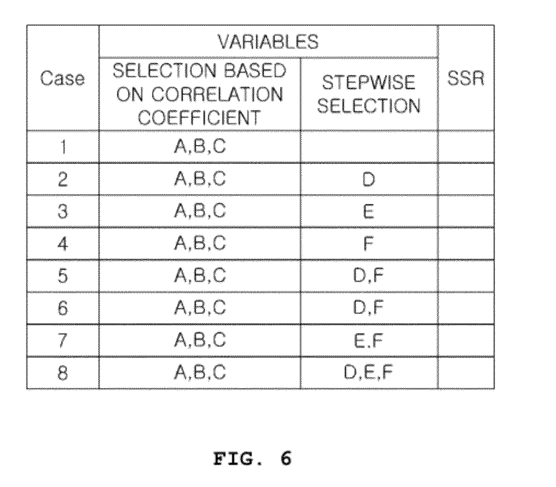

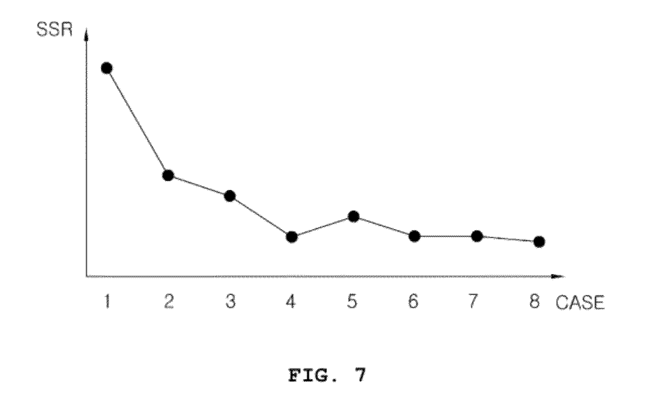

Consequently, a stepwise variable selection method is suggested as follows in order to more precisely construct grouping.
\textcircled{1} First, variables having a predetermined set value or an arbitrary value designated by a user, for example a value of 0.8 or more using a correlation coefficient are regarded as belonging to the same group.
\textcircled{2} A 4-fold validation method is used with respect to the variables of the group constructed in \textcircled{1} to calculate a smoothness parameter. In the 4-fold validation method, learning data are divided into four equal parts, data corresponding to three equal parts are used to form an autocorrelation regression analysis model, and the remaining data are used to verify the model, which are repeated in other combinations. In this way, verification is performed four times. Among them, the data corresponding to three equal parts used to make the autocorrelation regression analysis model are referred to as learning data, the data corresponding to the remaining one equal part used to verify the regression analysis model are referred to as testing data. Each verification step is referred to as a run. In the 4-fold validation method, therefore, four runs are performed. A square sum of residuals (SSR) between an input signal and an output signal is used as an index indicating excellence of the regression analysis model. At this time, the calculated square sum of residuals (SSR) is defined as SSR₁.
\textcircled{3} Combinations of all different variables, not variables belonging to the same group, are included in the group constructed in \textcircled{1}, and a square sum of residuals (SSR) is calculated using the 4-fold validation method while a smoothness parameter is calculated. A square sum of residuals of an i-th combination according to the sequence of the combinations is defined as SSRᵢ.
\textcircled{4} As shown in a table of FIG. 6 and in a graph of FIG. 7, a square sum of residuals (SSR) is decreased as the number of variables belonging to a group is increased. However, including too many variables in the same group may cause other problems. For this reason, grouping is terminated in case 4, at which SSRᵢ is slightly reduced. This may be normalized as follows. If a decrease ratio of a square sum of residuals immediately after a square sum of specific residuals to the square sum of specific residuals is equal to or less than a set value, grouping may be terminated at the time when the square sum of specific residuals is calculated. Here, the set value may be decided as a ratio of a decrease ratio of a square sum of residuals in case 5 to the square sum of specific residuals in case 4 to a decrease ratio of a square sum of residuals in case 4 to the square sum of specific residuals in case 3 shown in FIG. 7. That is, such a set value may be understood as a value to sort a state in which a square sum of residuals is suddenly slowed or is not decreased any more. Consequently, in case of FIGS. 6 and 7, variables A, B, C, and F are decided as belonging to the same group.
\textcircled{5} In actuality, combinations of a great number of variables must be considered, and therefore, there is a possibility that much time is necessary to perform the case of \textcircled{3}. In this case, variables related to characteristics of the equipment are decided as independent variables in consideration of characteristics of the equipment, and the case of \textcircled{3} is performed only with respect to the independent variables.

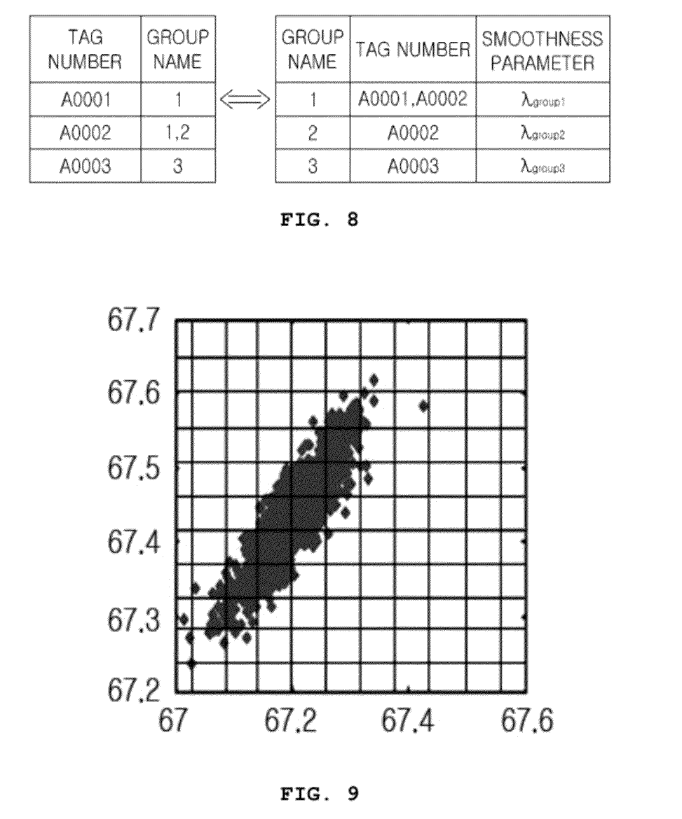

The second problem is automatically solved using the stepwise variable selection method as described above. Stepwise variable selection results and cross variable grouping results are shown in FIG. 8. Three variables A0001, A0002, and A0003 shown in FIG. 8 belong to groups 1, 2, and 3, respectively. In particular, FIG. 8 shows that a variable A0002 belongs to group 1.

(6) A Method of Reducing Collected Data to Such an Extent that Learning is Actually Possible

Learning data that can be actually collected are too much to be analyzed by the latest computer. In this case, a huge amount of time is necessary for stepwise variable selection and cross grouping of \textcircled{5}.

In order to solve this problem, dispersion of a signal is performed on the basis of a grid size, and a method of reducing the number of data in corresponding data is suggested as follows. First, dispersion of a value of a specific variable is calculated, and the calculated dispersion is set as a reference grid size. A user may set the reference grid size to be large or small. Next, a grid is set for each variable, and real data are dotted in each grid.

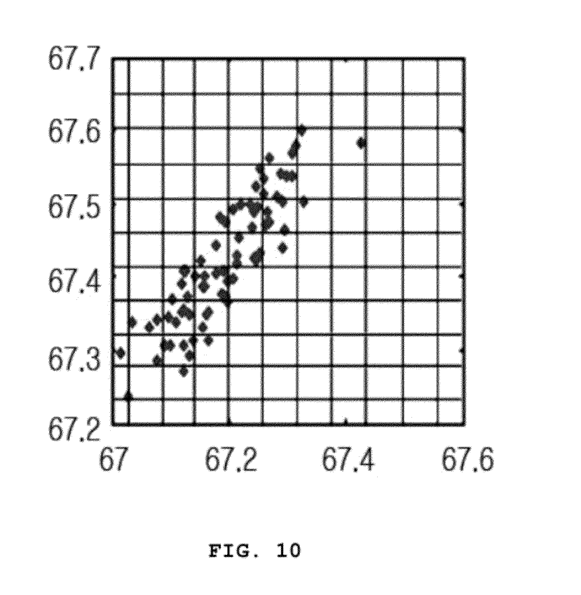

FIGS. 9 and 10 illustrate a case having two variables. First, FIG. 9 shows original data. Grids drawn on the horizontal axis and the vertical axis are decided by dispersion sizes of a variable corresponding to the horizontal axis and a variable corresponding to the vertical axis.

For a system having two variables, in a case in which variables are divided into grids having a predetermined resolution for each variable, and duplicated data are removed from one grid, if the duplicated data are present in the grid, the result data can be reduced as shown in FIG. 10. Using this method, it is possible to adjust the size of the grid, thereby calculating an appropriate scale of learning data. If the size of the grid is set to be large, the number of data is greatly reduced with the result that learning time is decreased; however, accuracy of regression analysis is relatively lowered. On the other hand, if the size of the grid is set to be small, the number of data is increased with the result that learning time is increased; however, it is possible to acquire relatively accurate regression analysis result. Although the resolution of the grid may be differently set for each variable, several thousands of variables or tens of thousands of variables are generally used for learning in a power plant. For this reason, setting the resolution of the grid for each variable is troublesome and not efficient. Consequently, a method of deciding what resolution the grid has through a setting interface before learning is proposed. The resolution means what equal parts a variable is divided into in the entire distribution. That is, as the resolution is set to be larger, the variable is divided into smaller grids with the result that an amount of learning data is increased. The size of grids GridSize_{X} according to resolution may be calculated by the following mathematical expression 2 based on standard deviation σ_{X} of a corresponding variable.

$${GridSize}_{X} = \frac{10 {σ}_{X}}{Resolution} \qquad [ Mathematical expression 2 ]$$

When the resolution is decided by the learning setting interface, a corresponding variable is divided into equal parts corresponding to the resolution from an average to −5σ to +5σ thereof. At this time, the reason that the minimum value to the maximum value of the variable is not divided by the resolution but −5σ to +5σ of the variable is divided by the resolution is that abnormally large or small values may be occasionally included in learning data, and therefore, if the minimum value and the maximum value of the variable are used, the grids may be abnormally distributed. Variables are naturally distributed, and therefore, most data are distributed between −5σ to +5σ of the variable. For example, when the resolution is set to 4, the variable may be divided into four grids, i.e. a grid of −5σ to −2.5 σ, a grid of −2.5 σ to an average, a grid of the average to +2.5 σ, and a grid of +2.5 σ to +5σ. On the other hand, when the resolution is set to 2, the variable may be divided into two grids, i.e. a grid of −5σ to an average and a grid of the average to +5σ.

Next, a predetermined rate or a certain rate input by a user is used to reduce the number of data included in each grid. The number of data in each of the grids is reduced according to such a rate. Although data are reduced according to this rate, at least one of the data must be left. FIG. 10 shows the remaining data after removal of data according to the above principle. When a signal is predicted in kernel regression analysis, the distance from all data is converted and reflected. Most process variables are normally distributed. Consequently, learning data are concentrated upon the central point of the entire section. This affects signal prediction with the result that prediction values are generally concentrated on the center. However, it is difficult to completely exclude importance of data occasionally located outside. Using this method, the number of data is reduced in consideration of data distribution, and therefore, it is possible to effectively reduce the number of data without losing important data.

The data compression method may be variously used in the statistical learning method. In order to achieve the greatest effect, variables must be grouped first, and then data compression must be performed in the same group. This is because if the data compression method is applied to a signal upon which signal processing is not performed, compression effects may be reduced.

As is apparent from the above description, the present invention has the effect of collecting learning data from a database of a computer in a power plant and converting the data into a form in which the data can be easily learned in realizing a monitoring system for analyzing process margin of industrial equipment based on a statistical learning method.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A data collection method for a process margin monitoring system of industrial equipment, comprising:
preparing a learning data set based on data determined to be normal in an operation history of the industrial equipment so that the learning data set is sorted for each operation mode;
in a case in which the industrial equipment comprises a plurality of equipment units performing the same functions, receiving data for each of the equipment units and processing the received data as data for the equipment units;
sorting and grouping associated ones of the data in the learning data set; and
sampling the collected data to reduce the number of data.

2. The data collection method according to claim 1, wherein the learning data set comprises a first data set to an N-th data set (N being a natural number equal to or greater than 2) depending upon a scale of data to be collected or time when data are collected.

3. The data collection method according to claim 2, wherein the first data set comprises signals related to a specific equipment unit of the industrial equipment for monitoring process margin of the specific equipment unit, the second data set comprises signals related to the entirety of the industrial equipment for monitoring process margin of the entirety of the industrial equipment, and
the third data set comprises signals regarding the entirety or a portion of the industrial equipment immediately after a specific event is generated in the entirety or the portion of the industrial equipment.

4. The data collection method according to claim 1, further comprising, in a case in which the learning data set comprises data displayed as digital signals, collecting analog signal that can substitute for the digital signal and converting the digital signal into the analog signal.

5. The data collection method according to claim 1, wherein the grouping step comprises:
regarding variables, a correlation coefficient between which is equal to or greater to a set value, as belonging to the same group;
calculating a smoothness parameter with respect to the variables regarded as belonging to the same group using a 4-fold validation method;
putting combinations of all variables in the group besides the variables regarded as belonging to the same group to calculate a square sum of residuals while calculating the smoothness parameter using the 4-fold validation method; and
in a case in which a decrease ratio of a square sum of residuals immediately after a square sum of specific residuals to the square sum of specific residuals is equal to or less than a set value, terminating grouping at a time when the square sum of specific residuals is calculated.

6. The data collection method according to claim 5, wherein the step of calculating the square sum of residuals comprises sorting and using only variables related to characteristics of the equipment among the variables besides the variables regarded as belonging to the same group in consideration of characteristics of the equipment.

7. The data collection method according to claim 5, wherein the correlation coefficient is analyzed by the following mathematical expression.
$${ρ}_{XY} = \frac{1}{N} {\sum }_{i = 1}^{N} ( \frac{{X}_{i} - {μ}_{X}}{{σ}_{X}} ) ( \frac{{Y}_{i} - {μ}_{Y}}{{σ}_{Y}} )$$
Where, ρ_{XY} indicates a correlation coefficient between variables X and Y, Xᵢ indicates an i-th value on the basis of a sampling section of learning data, Yᵢ indicates an i-th value on the basis of a sampling section of learning data (Y is a variable different than X), μ_{X} indicates the average of a variable X, μ_{Y} indicates the average of a variable Y, σ_{X} indicates standard deviation of a variable X, σ_{Y} indicates standard deviation of a variable Y, and N indicates the number of data collection intervals in a sampling section of learning data.

8. The data collection method according to claim 1, wherein the data sampling step comprises performing dispersion of a value of a specific variable on the basis of a grid size to reduce the number of data related to the variable in a corresponding grid.

9. The data collection method according to claim 1, wherein the data sampling step comprises calculating standard deviation (σ_{X}) of a value of a specific variable and reducing the number of data related to the variable in a corresponding grid on the basis of a grid size (GridSize_{X}) calculated by the following mathematical expression according to set resolution.
$${GridSize}_{X} = \frac{10 {σ}_{X}}{Resolution}$$

10. The data collection method according to claim 8, wherein the number of data left in the grid is decided by the product of the number of data related to the variable in the corresponding grid and a set rate, and at least one of the data is left in each grid.

11. A storage medium for storing a data collection method according to claim 1, wherein the data collection method is computer programmed.

12. The data collection method according to claim 9, wherein the number of data left in the grid is decided by the product of the number of data related to the variable in the corresponding grid and a set rate, and at least one of the data is left in each grid.

13. A storage medium for storing a data collection method according to claim 2, wherein the data collection method is computer programmed.

14. A storage medium for storing a data collection method according to claim 3, wherein the data collection method is computer programmed.

15. A storage medium for storing a data collection method according to claim 4, wherein the data collection method is computer programmed.

16. A storage medium for storing a data collection method according to claim 5, wherein the data collection method is computer programmed.

17. A storage medium for storing a data collection method according to claim 6, wherein the data collection method is computer programmed.

18. A storage medium for storing a data collection method according to claim 7, wherein the data collection method is computer programmed.

19. A storage medium for storing a data collection method according to claim 8, wherein the data collection method is computer programmed.

20. A storage medium for storing a data collection method according to claim 9, wherein the data collection method is computer programmed.
